(19) United States
(12) Patent Application Publication
(10) Pub. No.: US 2013/0258293 A1
(43) Pub. Date: Oct. 3, 2013

(54) Phase Modulation Module and Projector Comprising the Same

(71) Applicant: TOUCH MICRO-SYSTEM TECHNOLOGY CORP., Yangmei City (TW)

(72) Inventors: Lung-Han Peng, Yangmei City (TW); Chih-Ming Lai, Yangmei City (TW); Hoang-Yan Lin, Yangmei City (TW); Yung-Ming Lin, Yangmei City (TW); Po-Chun Yeh, Yangmei City (TW); Yan-Shuo Chang, Yangmei City (TW); Juei-Hung Hung, Yangmei City (TW)

(73) Assignee: Touch Micro-System Technology Corp., Yangmei City (TW)

(21) Appl. No.: 13/799,206

(22) Filed: Mar. 13, 2013

(30) Foreign Application Priority Data
Mar. 27, 2012 (TW) 101110462
Feb. 27, 2013 (TW) 102106810

(51) Int. Cl. G02F 1/01

(52) U.S. Cl. CPC G02F 1/0102
USPC 353/31; 359/279

(57) ABSTRACT

An optical phase modulation module and a projector comprising the same are provided. The optical phase modulation module comprises a transparent thin film with an electro-optic effect, a plurality of first upper electrodes, a plurality of second upper electrodes and a plurality of lower electrodes. The transparent thin film with the electro-optic effect has a top surface and a bottom surface. The first upper electrodes are formed on the top surface. The second upper electrodes are formed on the top surface and arranged alternately with the first upper electrodes. The lower electrodes are formed on the bottom surface. A first voltage difference exists between the first upper electrodes and the bottom electrodes, while a second voltage difference exists between the second upper electrodes and the bottom electrodes. Two different electric fields are produced within the transparent thin film with the electro-optic effect by the first voltage difference and the second voltage difference respectively.

This application claims the benefit of priority based on Taiwan Patent Application No. 101110462 filed on Mar. 27, 2012 and Taiwan Patent Application No. 102106810 filed on Feb. 27, 2013, which is hereby incorporated by reference in its entirety

### CROSS-REFERENCES TO RELATED APPLICATIONS

Not applicable.

### BACKGROUND OF THE INVENTION

1. Field of the Invention

The present invention relates to an optical phase modulation module and a projector comprising the same. More particularly, the optical phase modulation module of the present invention can be disposed in a projection device or a display device with a laser light source. Laser rays generated by the laser light source will have different phases after transmission through the optical phase modulation module.

2. Descriptions of the Related Art

Over recent years, many projection devices and display devices using laser light sources as light sources thereof have become available in the market due to advantages, such as high intensity and low divergence of the laser. The laser light sources for projection or displaying purposes are usually in forms of dot light sources, line light sources or surface light sources. The brightness of pixels are adjusted by a liquid crystal cell, a digital movable mirror or a grating light valve (GLV), and then the image pixels are projected onto a screen through raster scanning, line scanning or image projection.

However, because the laser light has a high coherence in spatial and time phases, an optical interference effect will happen when the laser light is scattered by the screen. When being viewed by human eye, the scattered laser light will cause glaring noises (commonly called “speckles”) on the pixels. Consequently, the speckles caused by the high coherence will degrade the imaging quality of the image pixels.

Accordingly, an urgent need exists in the art to provide a solution capable of improving the speckles caused by the high coherence of the laser light to improve the imaging quality of the image pixels.

### SUMMARY OF THE INVENTION

An objective of the present invention is to provide an optical phase modulation module and a projector comprising the same. The optical phase modulation module of the present invention can be disposed in a projection device or a display device with a laser light source. The laser rays generated by the laser light source will have different phases after transmission through the optical phase modulation module. Thereby, the present invention can effectively improve the problem of speckles caused by the high coherence of laser light, and thus can improve the imaging quality of image pixels of the projector.

To achieve the aforesaid objective, the present invention provides an optical phase modulation module, which comprises a transparent thin film with an electro-optic effect, a plurality of first upper electrodes, a plurality of second upper electrodes and a plurality of lower electrodes. The transparent thin film with an electro-optic effect has a top surface and a bottom surface. The plurality of first upper electrodes is formed on the top surface. The plurality of second upper electrodes is formed on the top surface and arranged alternately with the first upper electrodes. The plurality of lower electrodes is formed on the bottom surface. A first voltage difference exists between the first upper electrodes and the lower electrodes, while a second voltage difference exists between the second upper electrodes and the lower electrodes. Two different electric fields are produced within the transparent thin film with the electro-optic effect by the first voltage difference and the second voltage difference respectively.

In addition, the present invention further provides a projector, which comprises a light source module, at least one optical phase modulation module as described above and an imaging module. The light source module is configured to emit a first light beam. The first light beam is changed into a second light beam when propagating through the optical phase modulation module and the imaging module.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an optical phase modulation module according to the first embodiment of the present invention;

FIG. 2 is a schematic view of a transparent thin film with an electro-optic effect according to the second embodiment of the present invention;

FIG. 3 is a schematic view of an optical phase modulation module according to the third embodiment of the present invention;

FIG. 4 is a schematic view of a projector according to the fourth embodiment of the present invention;

FIG. 5 is a schematic view of a projector according to the fifth embodiment of the present invention;

FIG. 6 is a schematic view of a projector according to the sixth embodiment of the present invention;

FIG. 7 is a schematic view of a projector according to the seventh embodiment of the present invention; and

FIG. 8 is a schematic view of a projector according to the eighth embodiment of the present invention.

### DESCRIPTION OF THE PREFERRED EMBODIMENT

The present invention relates to an optical phase modulation module and a projector comprising the same. It shall be appreciated that the following embodiments are only intended to exemplify the technical contents of the present invention, but not to limit the scope of the present invention. In the following embodiments and attached drawings, elements unrelated to the present invention are omitted from depiction; and dimensional relationships among the individual elements in the attached drawings are illustrated only for the ease of understanding, but not to limit the actual scale. Further, spatial relationships, such as “front”, “behind” and “between”, among the individual elements of the present invention are determined by the propagating route of the laser light rather than to indicate particular spatial relationships among the elements.

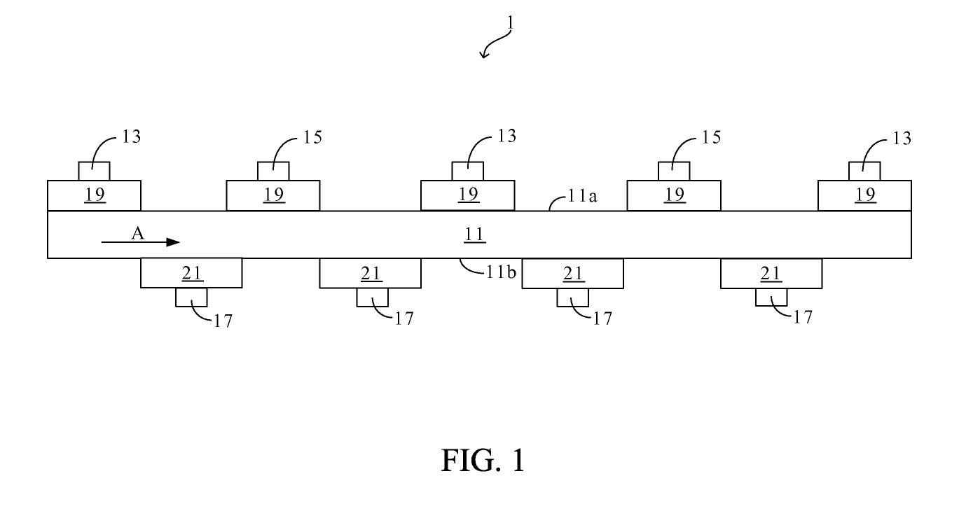

The first embodiment of the present invention is shown in FIG. 1, which is a schematic view of an optical phase modulation module 1 according to the present invention. The optical phase modulation module 1 comprises a transparent thin film 11 with an electro-optic effect, a plurality of first upper electrodes 13, a plurality of second upper electrodes 15, a plurality of lower electrode 17, a plurality of upper transparent conductive films 19 and a plurality of lower conductive films 21.

The transparent thin film 11 with the electro-optic effect has a top surface 11a and a bottom surface 11b. The first upper electrodes 13 and the second upper electrodes 15 are formed on the top surface 11a and arranged alternately with each other. The lower electrodes 17 are formed on the bottom surface 11b. The first upper electrodes 13, the second upper electrodes 15 and the lower electrodes 17 are made of a transparent material (e.g., a metal oxide), and are electrically connected to different alternate current (AC) or direct current (DC) voltage sources respectively so that a first voltage difference exists between the first upper electrodes 13 and the lower electrodes 17 and a second voltage difference exists between the second upper electrodes 15 and the lower electrodes 17. Furthermore, the upper transparent conductive films 19 may be formed between the top surface 11a and the first upper electrodes 13 and between the top surface 11a and the second upper electrodes 15 so that the voltages from the first upper electrodes 13 and the second upper electrodes 15 are applied to the top surface 11a uniformly. Similarly, the lower transparent conductive films 21 may be formed between the bottom surface 11b and the lower electrodes 17 so that the voltage from the lower electrodes 17 is applied to the bottom surface 11b uniformly.

It shall be noted that because the upper transparent conductive films 19 and the lower transparent conductive films 21 are used to assist the electrodes in applying the voltages to the surfaces of the transparent thin film 11 uniformly, they may also be omitted from the optical phase modulation module 1. The upper transparent conductive films 19 and the lower transparent conductive films 21 may be made from any of the following components: an indium tin oxide (ITO), a zinc oxide (ZnO), an indium gallium zinc oxide (IGZO), an aluminum-doped zinc oxide (AZO), a gallium-doped zinc oxide (GZO), a fluorine-doped tin oxide (FTO), a polyacetylene, a polyaniline, a polythiophene, a polypyrrole, carbon nanotubes or a fullerene.

The transparent thin film 11 with the electro-optic effect is made of a material whose optical property changes in response to an externally applied electric field. As used herein, the term “electro-optic effect” refers to the Pockels effect (also known as the “linear electro-optic effect”), which is a phenomenon in which an externally applied electric field causes a change in refractive index of crystals in direct proportion to the strength of the electric field, and this property only occurs in crystals that lack inversion symmetry.

Because the first voltage difference between the first upper electrodes 13 and the lower electrodes 17 is different from the second voltage difference between the second upper electrodes 15 and the lower electrodes 17, two different electric fields are generated within the transparent thin film 11 with the electro-optic effect by the first voltage difference and the second voltage difference respectively. In this case, the transparent thin film 11, with the electro-optic effect, has different optical properties along the A direction (i.e., have changes in refractive index), so when a laser light is transmitted through the optical phase modulation module, different parts of the laser light will have different optical path differences due to the different propagating routes thereof. As a result, the different parts of the laser light will have different phases. In this way, the problem of high coherence of the laser light can be improved to mitigate the speckle phenomenon.

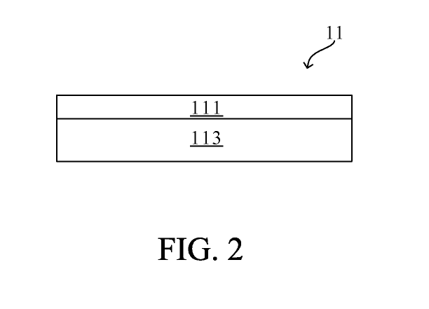

The second embodiment of the present invention is further depicted in FIG. 2. Herein, “High mobility thin film transistors with indium oxide/gallium oxide bi-layer structures” (S.-L. Wang et al., Appl. Phys. Lett. 100, 063506 (2012)) is incorporated herein by reference in its entirety. The transparent thin film with the electro-optic effect may be (but not limited thereto) formed by stacking at least two of the following: uniaxial materials such as a zinc oxide, a lithium niobate and a lithium tantalate, biaxial materials such as KTP, or a gallium nitride, an aluminum nitride, a gallium oxide, an aluminum oxide, a hafnium oxide or other binary, ternary or quaternary nitrides, and has a thickness less than 10 μm. In this embodiment, the transparent thin film 11 with the electro-optic effect is formed by a Ga₂O₃ layer 111 and an In₂O₃ layer 113 stacked together as shown in FIG. 2. A ratio (t_{In2O3})/(t_{Ga2O3})) of a thickness (t_{In2O3}) of the In₂O₃ layer 113 to a thickness (t_{Ga2O3}) of the Ga₂O₃ layer 111 ranges between 2.5 and 8. For example, values of t_{In2O3} and t_{Ga2O3} may be shown in the following table.

| | t_{In}_{₂}_{O}_{₃} | t_{Ga}_{₂}_{O}_{₃} |
|---|---|---|
| | (nm) | (nm) |
| Example 1 | 4.06 | 0.54 |
| Example 2 | 3.92 | 0.63 |
| Example 3 | 3.71 | 0.63 |
| Example 4 | 3.5 | 0.63 |
| Example 5 | 3.8 | 0.7 |
| Example 6 | 3.64 | 0.81 |
| Example 7 | 3.5 | 0.9 |
| Example 8 | 3.36 | 0.99 |
| Example 9 | 3.22 | 1.08 |

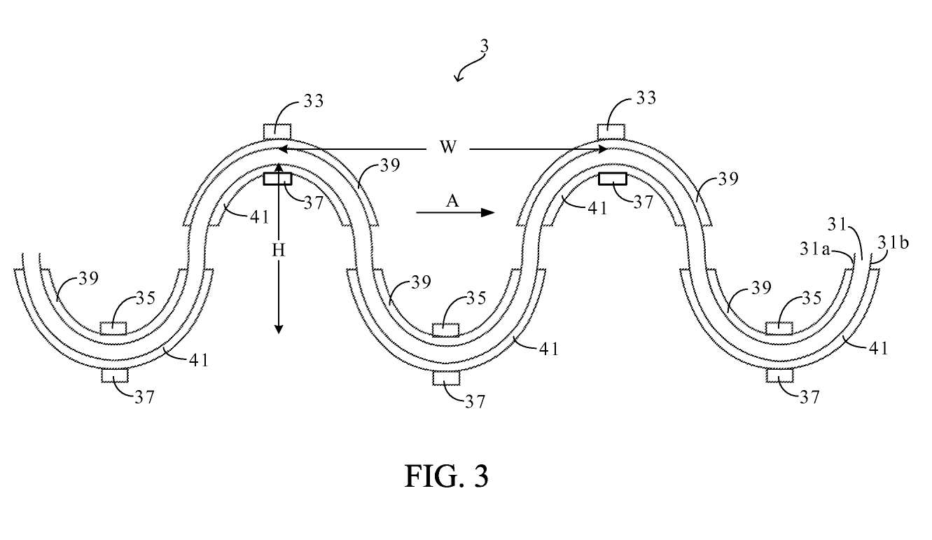

The third embodiment of the present invention is shown in FIG. 3, which is a schematic view of an optical phase modulation module 3 according to the present invention. The optical phase modulation module 3 comprises a transparent thin film 31 with an electro-optic effect, a plurality of first upper electrodes 33, a plurality of second upper electrodes 35, a plurality of lower electrodes 37, a plurality of upper transparent conductive films 39 and a plurality of lower transparent conductive films 41. In this embodiment, the transparent thin film 31, the first upper electrodes 33, the second upper electrodes 35, the lower electrodes 37, the upper transparent conductive films 39 and the lower transparent conductive films 41 are made of materials identical to those of the transparent thin film 11, the first upper electrodes 13, the second upper electrodes 15, the lower electrodes 17, the upper transparent conductive films 19 and the lower transparent conductive films 21 of the first embodiment respectively.

As compared to the first embodiment, the transparent thin film 31 of this embodiment has a longitudinal section in the form of a curved surface, as shown in FIG. 3. The curved surface has a waveform of a fixed period. The width W between the peak of the waveform and the adjacent peak of the waveform is smaller than half of the wavelength of a laser light. The height H between the peak and the trough of the waveform is greater than 125 nanometers (nm). For example, for a red laser light with a wavelength of 630 nm, the width W is 315 nm; for a green laser light with a wavelength of 532 nm, the width W is 266 nm; and for a blue laser light with a wavelength of 465 nm, the width W is 232.5 nm. It shall be appreciated that the present disclosure is suitable for the visible light waveband (i.e., 400 nm-800 nm); as a result, the width W ranges between 200 nm and 400 nm. The red laser light, the green laser light and the blue laser light described above are only for purpose of illustration but not to limit the present invention.

Additionally, in this embodiment, the first upper electrodes 33 are formed on the top surface 31a and each at a peak of the waveform, while the second upper electrodes 35 are formed on the top surface 31a and each at a trough of the waveform. The upper transparent conductive films 39 may also be formed between the top surface 31a and the first upper electrodes 33 and between the top surface 31a and the second upper electrodes 35. The longitudinal section is in the form of a curved surface so that the voltages from the first upper electrodes 33 and the second upper electrodes 35 are applied to the top surface 31a uniformly. Similarly, the lower transparent conductive films 41 may also be formed between the bottom surface 31b and the lower electrodes 37, and has a longitudinal section in the form of a curved surface so that the voltage from the lower electrodes 37 is applied to the bottom surface 31b uniformly.

Similar to the first embodiment, the first upper electrodes 33, the second upper electrodes 35 and the lower electrodes 37 are electrically connected to different AC voltage sources respectively so that a first voltage difference exists between the first upper electrodes 33 and the lower electrodes 37 and a second voltage difference exists between the second upper electrodes 35 and the lower electrodes 37. Because the first voltage difference between the first upper electrodes 33 and the lower electrodes 37 is different from the second voltage difference between the second upper electrodes 35 and the lower electrodes 37, two different electric fields are generated within the transparent thin film 31 by the first voltage difference and the second voltage difference respectively. As a result, the transparent thin film 31 has different optical properties along the A direction. Furthermore, the transparent thin film 31 has a longitudinal section in the form of a curved surface, so when a laser light is transmitted through the optical phase modulation module 3, different parts of the laser light will have different optical path differences due to the different propagating routes thereof caused by different electric fields and curved surfaces and, consequently, have different phases. In this way, the problem of high coherence of the laser light can be improved to mitigate the speckle phenomenon.

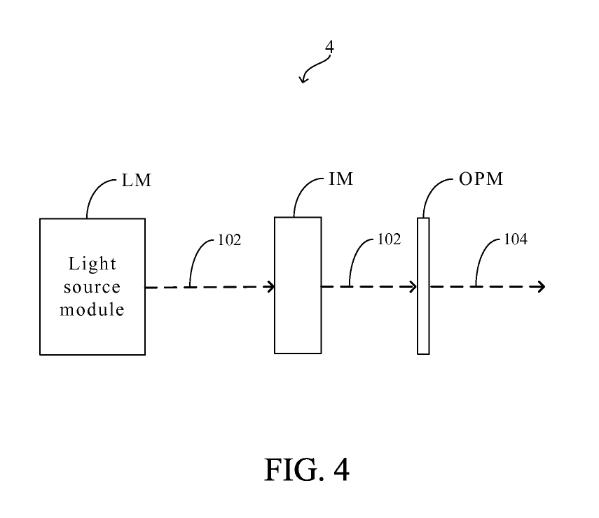

The fourth embodiment of the present invention is shown in FIG. 4, which is a schematic view of a projector 4 according to the present invention. The projector 4 comprises a light source module LM, an imaging module IM and an optical phase modulation module OPM. The light source module LM is a laser light source module. The imaging module IM is, but is not limited to, a scanning mirror device or a digital micromirror device (DMD). The optical phase modulation module OPM may be the optical phase modulation module 1 of the first embodiment or the optical phase modulation module 3 of the third embodiment. It shall be noted that, for purpose of simplicity, other elements of the projector 4 such as a housing, a lens, a light guiding element, a power supplying module and elements less related to the present invention are omitted form depiction in the drawings.

The light source module LM emits a first light beam 102. The imaging module IM projects the first light beam 102 after it receives the first light beam 102, and the optical phase modulation module OPM generates a second light beam 104 after it receives the first light beam 102. Different parts of the second light beam 104, which is generated after the first light beam 102 is transmitted through the optical phase modulation module OPM, have different optical path differences due to the different propagating routes thereof caused by different electric fields and curved surfaces and, consequently, have different phases. Thereby, the speckle of the image pixels caused by the second light beam 104 is mitigated.

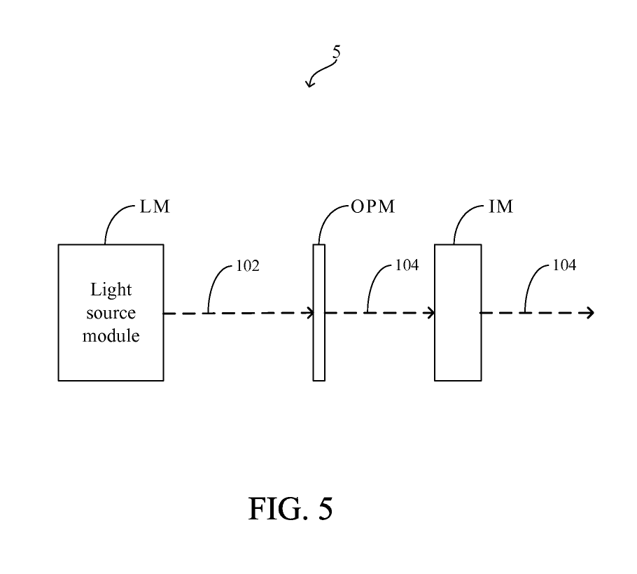

The fifth embodiment of the present invention is shown in FIG. 5, which is a schematic view of a projector 5 according to the present invention. Unlike the fourth embodiment, the optical phase modulation module OPM of this embodiment is disposed between the light source module LM and the imaging module IM. The optical phase modulation module OPM generates the second light beam 104 after it receives the first light beam 102. The imaging module IM projects the second light beam 104 after it receives the second light beam 104.

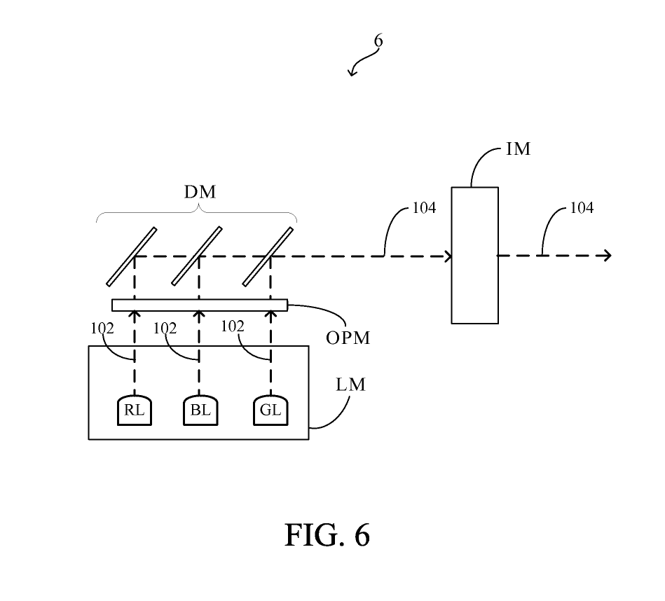

The sixth embodiment of the present invention is shown in FIG. 6, which is a schematic view of a projector 6 according to the present invention. As compared to the fifth embodiment, the projector 6 of this embodiment further comprises a light splitter module DM which is disposed between the light source module LM and the imaging module IM. The light source module LM comprises a red light source RL, a blue light source BL and a green light source GL. The optical phase modulation module OPM is disposed between the red light source RL, the blue light source BL, the green light source GL and the light splitter module DM.

The optical phase modulation module OPM generates the second light beam 104 after it receives the first light beam 102 generated by the red light source RL, the blue light source BL and the green light source GL. The second light beam 104 is guided to the imaging module IM via the light splitter module DM. The imaging module IM projects the second light beam 104 after it receives the second light beam 104.

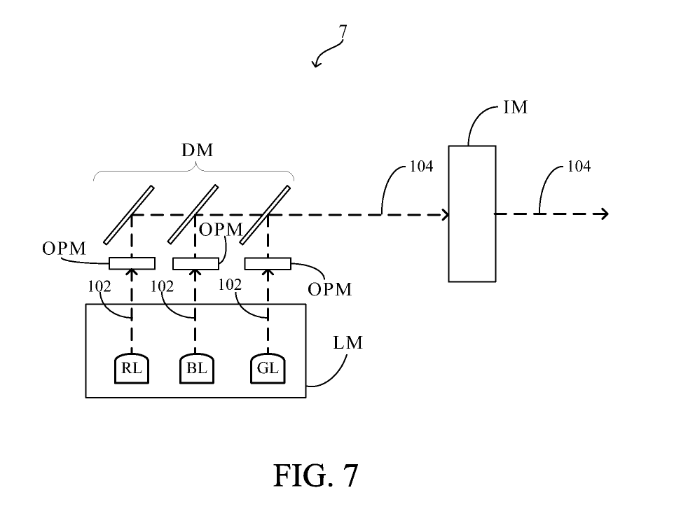

The seventh embodiment of the present invention is shown in FIG. 7, which is a schematic view of a projector 7 according to the present invention. As compared to the sixth embodiment, the projector 7 of this embodiment further comprises a plurality of optical phase modulation modules OPM which are disposed between the light source module LM and the light splitter module DM. In particular, the optical phase modulation modules OPM are respectively disposed between the red light source RL and the light splitter module DM, between the blue light source BL and the light splitter module DM, and between the green light source GL and the light splitter module DM to generate the second light beam 104 after it receives the first light beam 102 generated by the red light source RL, the blue light source BL and the green light source GL respectively.

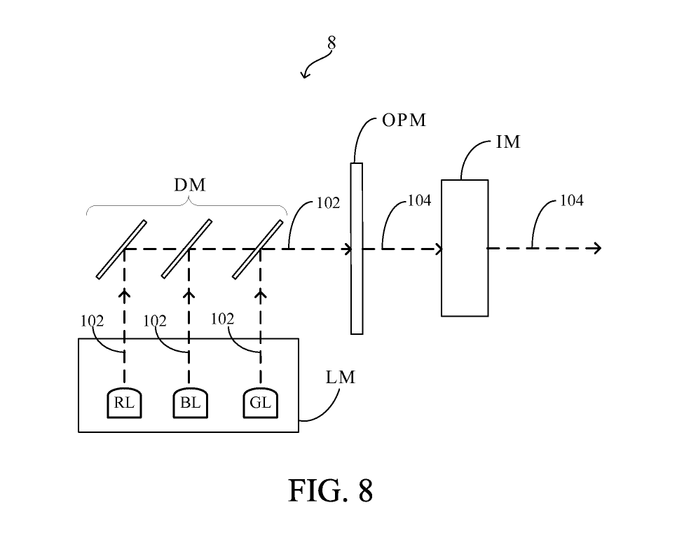

The eighth embodiment of the present invention is shown in FIG. 8, which is a schematic view of a projector 8 according to the present invention. This embodiment is different from the sixth embodiment in that, the optical phase modulation module OPM is disposed between the light splitter module DM and the imaging module IM. The first light beam 102 generated by the red light source RL, the blue light source BL and the green light source GL is guided to the optical phase modulation module OPM via the light splitter module DM. The optical phase modulation module OPM generates the second light beam 104 after it receives the first light beam 102. The imaging module IM projects the second light beam 104 after it receives the second light beam 104.

According to the above descriptions, the optical phase modulation module of the present invention can impart different phases to the laser light transmitting therethrough, so the problem of speckles caused by the high coherence of the laser light can be effectively improved. Thereby, when the optical phase modulation module of the present invention is disposed in a projection device or a display device with a laser light source, the imaging quality will be improved due to the improvement of the speckle problem.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. An optical phase modulation module, comprising:
a transparent thin film with an electro-optic effect, having a top surface and a bottom surface;
a plurality of first upper electrodes, being formed on the top surface;
a plurality of second upper electrodes, being formed on the top surface and arranged alternately with the first upper electrodes; and
a plurality of lower electrodes, being formed on the bottom surface,
wherein a first voltage difference exists between the first upper electrodes and the lower electrodes, a second voltage difference exists between the second upper electrodes and the lower electrodes, and two different electric fields are produced within the transparent thin film with the electro-optic effect by the first voltage difference and the second voltage difference.

2. The optical phase modulation module as claimed in claim 1, wherein the transparent thin film with the electro-optic effect has a longitudinal section in the form of a curved surface.

3. The optical phase modulation module as claimed in claim 2, wherein the curved surface has a waveform of a fixed period.

4. The optical phase modulation module as claimed in claim 3, wherein a width between a peak of the waveform and an adjacent peak of the waveform is smaller than a half of a wavelength of a laser.

5. The optical phase modulation module as claimed in claim 4, wherein a difference in height between a peak of the waveform and a trough of the waveform is greater than 125 nanometers (nm).

6. The optical phase modulation module as claimed in claim 3, wherein each of the first upper electrodes is formed at a peak of the waveform, and each of the second upper electrodes is formed at a trough of the waveform.

7. The optical phase modulation module as claimed in claim 1, wherein the transparent thin film with the electro-optic effect is a stacked structure, which is a combination of at least two selected from a group consisting of a lithium niobate, a lithium tantalate, a gallium nitride, an aluminum nitride, a gallium oxide, an aluminum oxide, a hafnium oxide and a zinc oxide.

8. The optical phase modulation module as claimed in claim 1, wherein the transparent thin film with the electro-optic effect has a thickness smaller than 10 micrometers (μm).

9. The optical phase modulation module as claimed in claim 1, wherein the transparent thin film with the electro-optic effect comprises a Ga₂O₃ layer and an In₂O₃ layer.

10. The optical phase modulation module as claimed in claim 9, wherein a ratio of a thickness of the In₂O₃ layer to a thickness of the Ga₂O₃ layer ranges between 2.5 and 8.

11. The optical phase modulation module as claimed in claim 1, further comprising:
a plurality of upper transparent conductive films, being formed between the top surface and the first upper electrodes and between the top surface and the second upper electrodes; and
a plurality of lower transparent conductive films, being formed between the bottom surface and the lower electrodes.

12. The optical phase modulation module as claimed in claim 11, wherein the upper transparent conductive films and the lower transparent conductive films are made of one of an indium tin oxide (ITO), a zinc oxide (ZnO), an indium gallium zinc oxide (IGZO), an aluminum-doped zinc oxide (AZO), a gallium-doped zinc oxide (GZO), a fluorine-doped tin oxide (FTO), a polyacetylene, a polyaniline, a polythiophene, a polypyrrole, carbon nanotubes and a fullerene.

13. A projector, comprising:
a light source module, being configured to emit a first light beam;
at least one optical phase modulation module as claimed in claim 1; and
an imaging module,
wherein, the first light beam is changed into a second light beam after propagating through the optical phase modulation module and the imaging module.

14. The projector as claimed in claim 13, wherein the imaging module projects the first light beam after it receives the first light beam, and the optical phase modulation module generates the second light beam after it receives the first light beam.

15. The projector as claimed in claim 13, wherein the optical phase modulation module generates the second light beam after it receives the first light beam, and the imaging module projects the second light beam after it receives the second light beam.

16. The projector as claimed in claim 15, further comprising a light splitter module which is disposed between the light source module and the imaging module, wherein the light source module comprises a red light source, a blue light source and a green light source, and the at least one optical phase modulation module is disposed between the red light source, the blue light source, the green light source and the light splitter module.

17. The projector as claimed in claim 16, wherein the projector comprises a plurality of the optical phase modulation modules, and the optical phase modulation modules are respectively disposed between the red light source and the light splitter module, between the blue light source and the light splitter module, and between the green light source and the light splitter module.

18. The projector as claimed in claim 15, further comprising a light splitter module which is disposed between the light source module and the imaging module, wherein the light source module comprises a red light source, a blue light source and a green light source, and the optical phase modulation module is disposed between the light splitter module and the imaging module.

19. The projector as claimed in claim 14, wherein the light source module is a laser light source module.

20. The projector as claimed in claim 15, wherein the light source module is a laser light source module.

21. The projector as claimed in claim 14, wherein the imaging module is a scanning mirror device or a digital micromirror device (DMD).

22. The projector as claimed in claim 15, wherein the imaging module is a scanning mirror device or a DMD.
